(19) United States
(12) Patent Application Publication
(10) Pub. No.: US 2014/0105645 A1
(43) Pub. Date: Apr. 17, 2014

(54) TITANIUM COROTRON AND SCOROTRON PINS

(71) Applicant: XEROX CORPORATION, Norwalk, CT (US)

(72) Inventors: Robert S. Pozniakas, Rochester, NY (US); Richard B. Gruszewski, Penfield, NY (US); Paul F. Sawicki, Rochester, NY (US)

(73) Assignee: Xerox Corporation, Norwalk, CT (US)

(21) Appl. No.: 13/651,495

(22) Filed: Oct. 15, 2012

(51) Int. Cl. G03G 15/02; H01T 19/00

(52) U.S. Cl. 399/170; 250/324; 399/172; 399/171

(57) ABSTRACT

A coronode charging device that is photo-etched with titanium which slows the erosion rate of the coronode and thereby enhances uniformity over a larger number of copies.

### BACKGROUND

Cross-reference is hereby made to commonly assigned and copending U.S. application Ser. No. 13/527,964, filed Jun. 20, 2012, and entitled “TITANIUM SCOROTRON GRID” by Robert Steven Pozniakas, et al. (Attorney No. 20120253). The disclosure of the heretofore-mentioned application is incorporated herein by reference in its entirety.

1. Field of the Disclosure

This disclosure relates generally to a corona generating device, and more particularly, concerns corona generating devices employing a titanium corotron or scorotron pins.

2. Description of Related Art

In a typical electrophotographic printing process, a photoconductive member is charged to a substantially uniform potential so as to sensitize the surface thereof. The charged portion of the photoconductive member is exposed to a light image of an original document being reproduced.

Exposure of the charged photoconductive member selectively dissipates the charges thereon in the irradiated areas. This records an electrostatic latent image on the photoconductive member corresponding to the informational areas contained within the original document. After the electrostatic latent image is recorded on the photoconductive member, the latent image is developed by bringing a developer material into contact therewith. Generally, the developer material comprises toner particles adhering triboelectrically to carrier granules. The toner particles are attracted from the carrier granules to the latent image forming a toner powder image on the photoconductive member. The toner powder image is then transferred from the photoconductive member to a copy sheet.

The toner particles are heated to permanently affix the powder image to the copy sheet.

In printing machines such as those described above, corona devices perform a variety of other functions in the printing process. For example, corona devices aid the transfer of the developed toner image from a photoconductive member to a transfer member. Likewise, corona devices aid the conditioning of the photoconductive member prior to, during, and after deposition of developer material thereon to improve the quality of the electrophotographic copy produced thereby. Both direct current (DC) and alternating current (AC) type corona devices are used to perform these functions.

One form of a corona charging device comprises a corona electrode in the form of an elongated wire connected by way of an insulated cable to a high voltage AC/DC power supply. The corona wire is partially surrounded by a conductive shield. The photoconductive member is spaced from the corona wire on the side opposite the shield. An AC voltage may be applied to the corona wire and at the same time, a DC bias voltage is applied to the shield to regulate ion flow from the corona wire to the photoconductive member being charged.

Another form of a corona charging device is pin corotrons and scorotrons. The pin corotron comprises an array of pins integrally formed from a sheet metal member that is connected by a high voltage cable to a high voltage power supply. The sheet metal member is supported between insulated end blocks and mounted within a conductive or insulative shield. The photoconductive member to be charged is spaced from the sheet metal member on the opposite side of the shield. The scorotron is similar to the pin corotron, but is additionally provided with a screen or control grid disposed between the coronode and the photoconductive member. The screen is held at a lower potential approximating the charge level to be placed on the photoconductive member. The scorotron screen is held in very close proximity to the photoconductive belt or drum, typically 1.5 to 2 mm distance and provides for more uniform charging and prevents overcharging. An example of a pin scorotron is shown in U.S. Pat. No. 7,933,537 B2, which is incorporated herein by reference.

The corona process erodes the pin tips leading to less uniform charge voltage on the photoreceptor belt or drum. Contaminants are also attracted to the pin tips, but are brushed off in many copiers and printers. Heretofore, these pin corotrons have been made of Phosphor bronze or Be Cu material with a pin life of about 2 million pages (Mp) for the charge corotron in some machines and about 4 Mp for pre-transfer and pre-clean, where the uniformity requirements are less. Replacing corotron devices at these number of pages is quite costly.

Hence, there is a continuing need for coronode that gives longer life and at lower service cost.

### BRIEF SUMMARY OF THE DISCLOSURE

Accordingly, provided hereinafter is a coronode charging device that is photo-etched with titanium that slows the erosion rate of the coronode and thereby enhances uniformity over a larger number of copies.

### BRIEF DESCRIPTION OF THE DRAWINGS

Various of the above-mentioned and further features and advantages will be apparent to those skilled in the art from the specific apparatus and its operation or methods described in the example(s) below, and the claims. Thus, they will be better understood from this description of these specific embodiment(s), including the drawing figures (which are approximately to scale) wherein:

FIG. 1 illustrates a configuration of a scorotron charging device useful in a printer apparatus;

FIG. 2 is a schematic elevational view depicting an illustrative high speed color electrophotographic printing machine incorporating the apparatus of the present disclosure therein;

FIG. 3 is a chart showing charge uniformity between new and used titanium pins; and

FIG. 4 is a chart showing charge uniformity between new and used phosphorus bronze pins.

### DETAILED DESCRIPTION OF THE PREFERRED EMBODIMENT

While the present disclosure will hereinafter be described in connection with a preferred embodiment, it will be understood that it is not intended to limit the disclosure to that embodiment. On the contrary, it is intended to cover all alternatives, modifications and equivalents as may be included within the spirit and scope of the invention as defined by the appended claims.

For a general understanding of the features of the present disclosure, reference is made to the drawings. In the drawings, like reference numerals have been used throughout to designate identical elements.

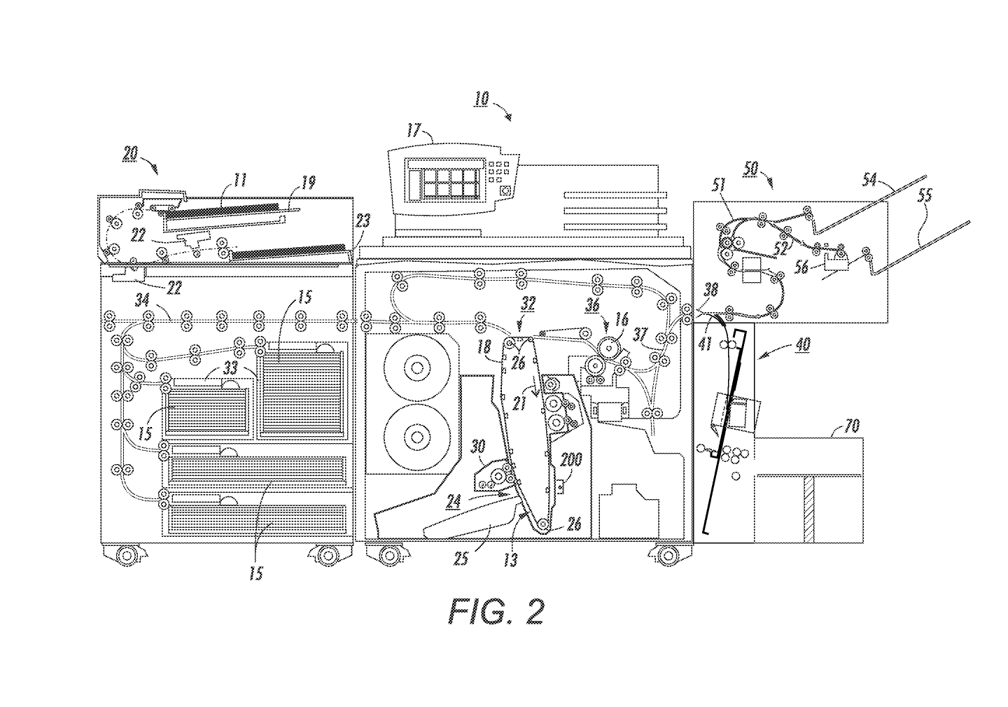

Referring to the FIG. 2 printer 10, as in other xerographic machines, and as is well known, an electronic document or an electronic or optical image of an original document or set of documents to be reproduced may be projected or scanned onto a charged surface 13 or a photoreceptor belt 18 to form an electrostatic latent image. Optionally, an automatic document feeder 20 (ADF) may be provided to scan at a scanning station 22 paper documents 11 fed from a tray 19 to a tray 23. The latent image is developed with developing material to form a toner image corresponding to the latent image. The toned image is then electrostatically transferred to a final print media material, such as, paper sheets 15, to which it may be permanently fixed by a fusing device 16. The machine user may enter the desired printing and finishing instructions through the graphic user interface (GUI) or control panel 17, or, with a job ticket, an electronic print job description from a remote source, or otherwise.

As the substrate passes out of the nip, it is generally self-stripping except for a very lightweight one. The substrate requires a guide to lead it away from the fuser roll. After separating from the fuser roll, the substrate is free to move along a predetermined path toward the exit of the printer 10 in which the fuser structure apparatus is to be utilized.

The belt photoreceptor 18 here is mounted on a set of rollers 26. At least one of the rollers is driven to move the photoreceptor in the direction indicated by arrow 21 past the various other known xerographic processing stations, here a charging station 200, imaging station 24 (for a raster scan laser system 25), developing station 30, and transfer station 32. A sheet 15 is fed from a selected paper tray supply 33 to a sheet transport 34 for travel to the transfer station 32. Paper trays 33 include trays adapted to feed the long edge of sheets first from a tray (LEF) or short edge first (SEF) in order to coincide with the LEF or SEF orientation of documents fed from tray 11 that is adapted to feed documents LEF or SEF depending on a user's desires. Transfer of the toner image to the sheet is effected and the sheet is stripped from the photoreceptor and conveyed to a fusing station 36 having fusing device 16 where the toner image is fused to the sheet. The sheet 15 is then transported by a sheet output transport 37 to a multi-function finishing station 50.

With further reference to FIG. 2, a simplified elevation view of multi-functional finisher 50 is shown including a modular booklet maker 40. Printed signature sheets from the printer 10 are accepted at an entry port 38 and directed to multiple paths and output trays for printed sheets, corresponding to different desired actions, such as stapling, hole-punching and C or Z-folding. It is to be understood that various rollers and other devices which contact and handle sheets within finisher module 50 are driven by various motors, solenoids and other electromechanical devices (not shown), under a control system, such as including a microprocessor (not shown), within the finisher module 50, printer 10, or elsewhere, in a manner generally familiar in the art.

Multi-functional finisher 50 has a top tray 54 and a main tray 55 and a folding and booklet making section 40 that adds stapled and unstapled booklet making, and single sheet C-fold and Z-fold capabilities. The finished booklets are then collected in a stacker 70. The top tray 54 is used as a purge destination, as well as, a destination for the simplest of jobs that require no finishing and no collated stacking. The main tray 55 has a pair of pass-through 100 sheet upside down staplers 56 and is used for most jobs that require stacking or stapling, and the folding destination 40 which includes an inlet baffle 41 is used to produce signature booklets, saddle stitched or not, and tri-folded. Sheets that are not to be C-folded, Z-folded or made into booklets or do not require stapling are forwarded along path 51 to top tray 54. Sheets that require stapling are forwarded along path 52, stapled with staplers 56 and deposited into the main tray 55. Conventional, spaced apart, staplers 56 are adapted to provide individual staple placement at either the inboard or outboard position of the sheets, as well as, the ability for dual stapling, where a staple is placed at both the inboard and outboard positions of the same sheets.

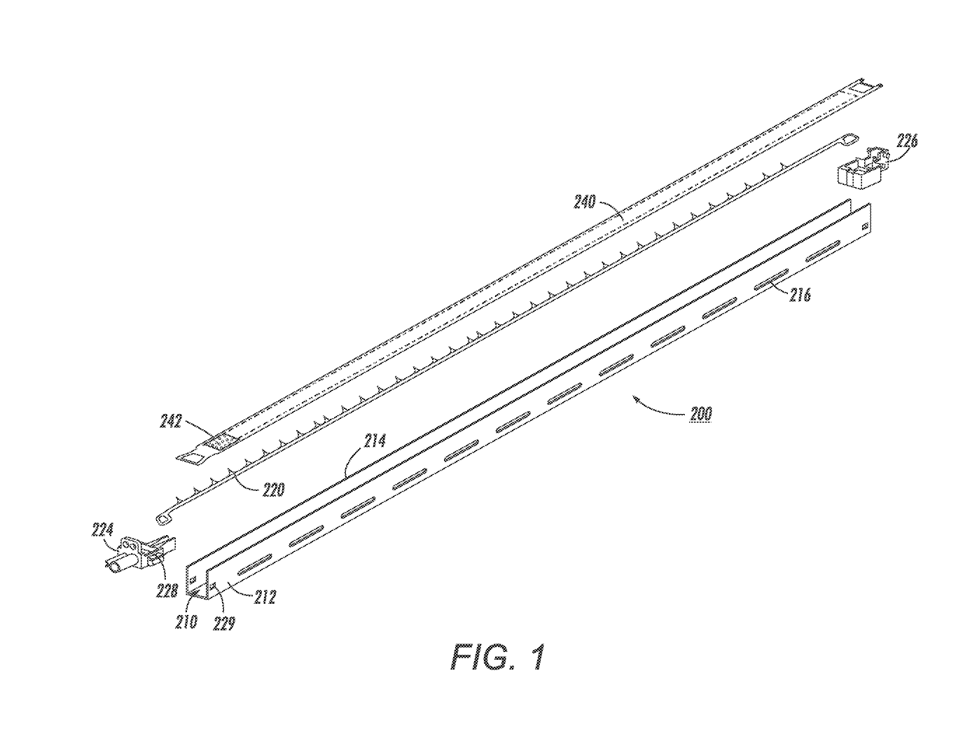

Turning now to FIG. 1, there is illustrated an example of a scorotron charging device 200 in accordance with the present disclosure that is useful in the printer apparatus of FIG. 1. Scorotron charging device 200 includes housing 210 comprising a generally U-shaped cross-sectional configuration having parallel side panels 212 and 214 defining a cavity therebetween that is composed of an insulated material such as plastic. A photo-etched titanium pin coronode 220 is located at a predetermined distance from the housing 210 and is powered by a conventional high voltage DC power supply (not shown). End mounting block 224 and 226 are included and are fixedly supported at opposite ends of the U-shaped housing 210 via cooperative engagement of mounting tabs 228, situated on either side of the mounting blocks, and fixed mounting support apertures 229 situated adjacent the opposite ends of U-shaped housing member 210, on the side panel members 212 and 214 thereof. Slots 216 are in side panels 212 and 214 to allow for evacuation of effluents with a conventional vacuum system. A screen member 240 is included and is interposed between the electrode 220 and the surface to be charged 13 while being detachably mounted to end blocks 224 and 226. Screen member 240 is included in FIG. 2. The use of a photo-etched titanium pin as a corotron or as the coronode in a scorotron is advantageous because it gives longer life and lower service costs in some imaging products. Titanium pin tips have a slower erosion rate, which is believed to be due to the much higher melting point than copper or bronze materials.

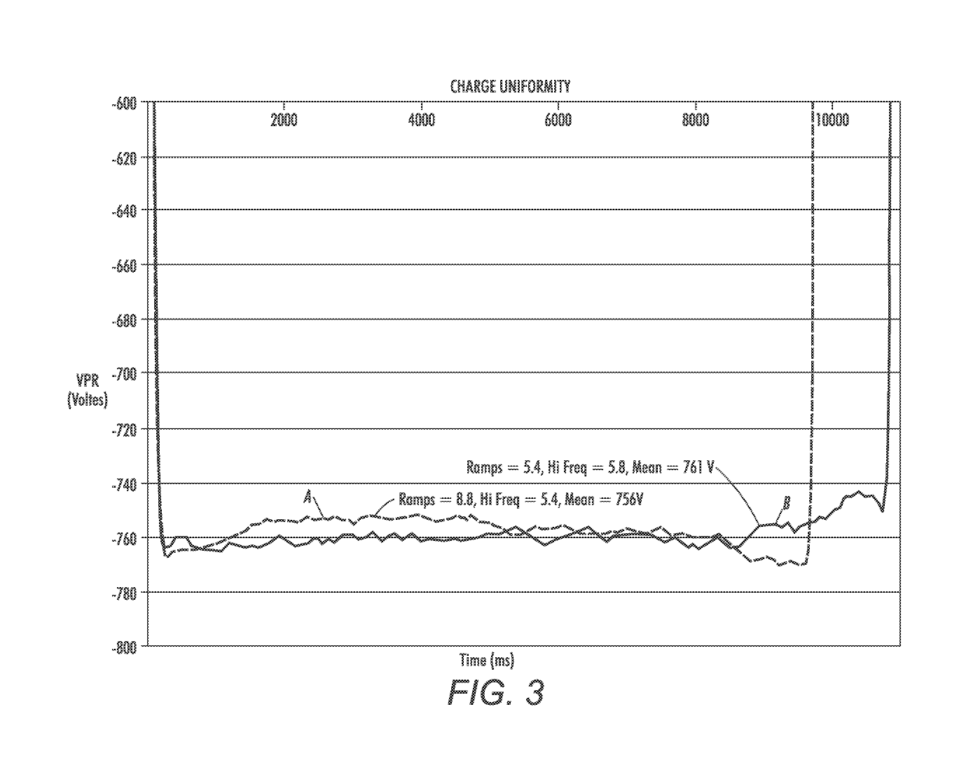

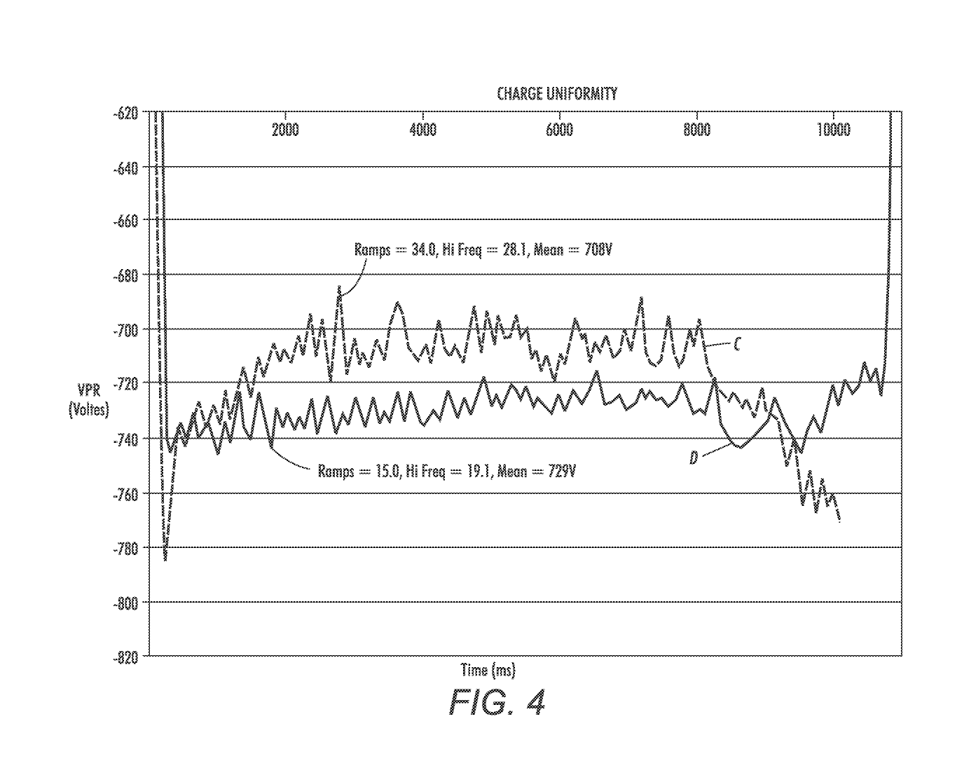

In FIG. 3, it is shown that the uniformity of a titanium corotron pin A is essentially equal to new titanium corotron pin B after 4M equivalent prints in an aging fixture. In comparison, FIG. 4 shows a wide disparity between uniformity of phosphorus bronze corotron pin C after 4M equivalent prints and a new bronze corotron pin D.

Is should now be apparent that a scorotron charging device has been disclosed that utilizes a titanium pin corotron to achieve improved resistance to erosion by corona generation and charge uniformity over a larger number or prints. The titanium pin corotron is produced through photo-etching and improves the life of the pin corotron.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

What is claimed is:

1. A charging device, comprising:
a housing, said housing including a member having side panels defining a cavity therebetween, and end members adapted to enclose opposite ends of said member; and
a titanium corona generating member detachably connected to said end members.

2. The charging device of claim 1, wherein said side panels of said housing includes evacuation slots therein which allow airborne contaminants to be evacuated from said housing.

3. The charging device of claim 1, including a grid positioned within said member and adapted to enclose a portion of said member and provide uniform charging to a charge receptor.

4. The charging device of claim 1, wherein titanium corona generating member is a pin corotron.

5. The charging device of claim 3, wherein said grid is adapted to be positioned about 1.5 mm away from a charge receptor surface.

6. The charging device of claim 3, wherein said grid is adapted to be positioned about 2 mm away from a charge receptor surface.

7. The charging device of claim 3, wherein said titanium corona generating member is in a sawtooth configuration.

8. An electrophotographic printing apparatus, comprising:
a charge receptor, said charge receptor being movable in a process direction;
a charging device for applying a charge to a surface of said charge receptor, said charge device having a corona member arranged in a plane oriented substantially parallel to said surface of said charge receptor; and
wherein said corona member is a titanium pin corotron.

9. The electrophotographic printing apparatus of claim 8, wherein said charging device includes a screen positioned between said charging device and said charge receptor.

10. The electrophotographic printing apparatus of claim 9, wherein said screen is adapted to be positioned about 1.5 mm away from said surface of said charge receptor.

11. The electrophotographic printing apparatus of claim 9, wherein said screen is adapted to be positioned about 2 mm away from said surface of said charge receptor.

12. The electrophotographic printing apparatus of claim 8, wherein said titanium pin corotron is photo-etched onto sheet metal.

13. A method for achieving improved charge uniformity in a printing apparatus, comprising:
providing a photoconductive member;
providing a charging device for applying a charge to a surface of said photoconductive member, said charge device having a corona member arranged in a plane oriented substantially parallel to said surface of said photoconductive member; and
providing said corona member as a titanium member.

14. The method of claim 13, including positioning a screen between said charging device and said photoconductive member.

15. The method of claim 13, including positioning said screen about 1.5 mm away from a surface of said photoconductive member.

16. The method of claim 13, including positioning said screen about 2 mm away from a surface of said photoconductive member.

17. The method of claim 13, including providing said titanium member in the form of a pin array.

18. The method of claim 13, including providing said titanium member in the form of a sawtooth shaped metal member.

19. The method of claim 13, wherein said titanium member comprises titanium photo-etched on to a metal member.

20. The method of claim 13, including providing said titanium member within a housing that includes evacuation slots therein which allow airborne contaminants to be evacuated from said housing.
